(19) United States
(12) Patent Application Publication
(10) Pub. No.: US 2014/0274290 A1
(43) Pub. Date: Sep. 18, 2014

(54) WAGERING GAME WITH POSITIONAL FEEDBACK FOR MECHANICAL REELS

(71) Applicant: WMS GAMING INC., Waukegan, IL (US)

(72) Inventor: Timothy C. Loose, Chicago, IL (US)

(73) Assignee: WMS Gaming Inc., Waukegan, IL (US)

(21) Appl. No.: 13/870,774

(22) Filed: Apr. 25, 2013

Related U.S. Application Data
(60) Provisional application No. 61/791,359, filed on Mar. 15, 2013.

(51) Int. Cl. G07F 17/34

(52) U.S. Cl. CPC G07F 17/34
USPC 463/20

(57) ABSTRACT

A method of conducting a wagering game on a gaming terminal includes receiving, via an input device, a wager to play the wagering game. Each of a plurality of symbol bearing reels is spun using one or more motors of the gaming terminal. During the spinning, the symbols on a first one of the reels are monitored using one or more video cameras to generate image data associated with the symbols on the first reel. The generated image data associated with the symbols on the first reel is compared with master image data associated with the wagering game. Based on the comparing, it is determined if the symbols on the first reel are associated with the wagering game being conducted on the gaming terminal.

### CROSS-REFERENCE TO RELATED APPLICATIONS

This application claims the benefit of U.S. Provisional Application No. 61/791,359, filed Mar. 15, 2013, which is hereby incorporated by reference herein in its entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to wagering games and, more particularly, to a wagering game with positional feedback for mechanical reels.

### BACKGROUND

Gaming machines or terminals, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing terminals and the expectation of winning each terminal is roughly the same (or believed to be the same), players are most likely to be attracted to the more entertaining and exciting terminal. As a result, wagering game machine operators strive to employ the most entertaining and exciting machines available, because such machines attract frequent play and provide increased profitability for the operators.

### SUMMARY OF THE INVENTION

According to some implementations of the present disclosure, a method of conducting a wagering game on a gaming terminal includes receiving, via an input device, a wager to play the wagering game. Each of a plurality of symbol bearing reels is spun using one or more motors of the gaming terminal. During the spinning, the symbols on a first one of the reels are monitored using one or more video cameras to generate image data associated with the symbols on the first reel. The generated image data associated with the symbols on the first reel is compared with master image data associated with the wagering game. Based on the comparing, it is determined if the symbols on the first reel are associated with the wagering game being conducted on the gaming terminal.

According to some implementations of the present disclosure, a method of verifying proper reel strip usage in an electronic gaming machine (“EGM”) includes storing game software on a memory of the EGM that is executable by one or more processors of the EGM to play a wagering game on the EGM. The game software is associated with a first plurality of symbols. A strip of symbols is provided on each one of a plurality of reel cages in the EGM for use in playing the wagering game, thereby forming a plurality of symbol bearing reels. Each of the plurality of symbol bearing reels is spun using one or more motors of the EGM under the control of at least one of the one or more processors of the EGM. During the spinning, each of the plurality of symbol bearing reels is monitored using one or more video cameras of the EGM. In response to the monitoring, image data associated with each of the symbol bearing reels is generated. The generated image data associated with each of the symbol bearing reels is compared, using at least one of the one or more processors of the EGM, with the first plurality of symbols associated with the game software stored on the memory of the EGM. Based on the comparing, it is verified if the provided strip of symbols on each one of the reel cages corresponds with the first plurality of symbols associated with the game software.

According to some implementations of the present disclosure, a gaming system for conducting a wagering game includes one or more symbol bearing reels; one or more motors; one or more video cameras; one or more processors; and one or more memory devices storing instructions that, when executed by at least one of the one or more processors, cause the gaming system to receive, via an input device of the gaming system, a wager to conduct the wagering game. The gaming system is further caused to spin the one or more symbol bearing reels using the one or more motors. During the spinning, the gaming system is further caused to monitor the symbols on a first one of the symbol bearing reels using the one or more video cameras to generate image data associated with the symbols on the first symbol bearing reel. The gaming system is further caused to compare the generated image data associated with the symbols on the first symbol bearing reel with master image data associated with the wagering game. Based on the comparing, the gaming system is further caused to determine if the symbols on the first symbol bearing reel are associated with the wagering game being conducted on the gaming system.

According to some implementations of the present disclosure, a gaming system for conducting a wagering game includes a plurality of symbol bearing reels. Each of the symbol bearing reels includes a reel cage and a strip of symbols attached thereto for use in playing the wagering game. The gaming system further includes a plurality of motors; one or more video cameras; one or more processors; and one or more memory devices that store game software that is executable by at least one of the one or more processors to play the wagering game. The game software is associated with a first plurality of symbols. At least one of the one or more memory devices stores instructions that, when executed by at least one of the one or more processors, cause the gaming system to spin, using the plurality of motors, the symbol bearing reels under the control of at least one of the one or more processors. The gaming system is further caused to monitor, during the spinning, using the one or more video cameras, the symbol bearing reels. In response to the monitoring, the gaming system is further caused to generate image data associated with each of the symbol bearing reels. The gaming system is further caused to compare, using at least one of the one or more processors, the generated image data associated with each of the symbol bearing reels with the first plurality of symbols associated with the game software stored on the one or more memory devices. Based on the comparing, the gaming system is further caused to verify if the strip of symbols attached to each one of the reel cages corresponds with the first plurality of symbols associated with the game software.

Additional aspects of the present disclosure will be apparent to those of ordinary skill in the art in view of the detailed description of various implementations, which is made with reference to the drawings, a brief description of which is provided below.

### BRIEF DESCRIPTION OF THE DRAWINGS

FIG. 1 is a perspective view of a free-standing gaming terminal according to some aspects of the present disclosure;

FIG. 2 is a schematic view of a gaming system according to some aspects of the present disclosure;

FIG. 3 is an image of an exemplary basic-game screen of a wagering game displayed on a gaming terminal according to some aspects of the present disclosure;

FIG. 4 is schematic diagram of a portion of a gaming terminal according to some aspects of the present disclosure; and

FIG. 5 is a side view of an internal portion of a gaming terminal according to some aspects of the present disclosure.

While the present disclosure is susceptible to various modifications and alternative forms, specific implementations have been shown by way of example in the drawings and will be described in detail herein. It should be understood, however, that the present disclosure is not intended to be limited to the particular forms disclosed. Rather, the disclosure is to cover all modifications, equivalents, and alternatives falling within the spirit and scope of the present invention as defined by the appended claims.

### DETAILED DESCRIPTION

While this disclosure is susceptible of embodiment in many different forms, there is shown in the drawings and will herein be described in detail preferred embodiments of the disclosure with the understanding that the present disclosure is to be considered as an exemplification of the principles of the disclosure and is not intended to limit the broad aspect of the disclosure to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering games,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game may involve wagers of real money, as found with typical land-based or on-line casino games. In other embodiments, the wagering game may additionally, or alternatively, involve wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

Referring to FIG. 1, there is shown a gaming terminal 10 similar to those used in gaming establishments, such as casinos. With regard to the present disclosure, the gaming terminal 10 may be any type of gaming terminal and may have varying structures and methods of operation. For example, in some aspects, the gaming terminal 10 is an electromechanical gaming terminal configured to play mechanical slots, whereas in other aspects, the gaming terminal is an electronic gaming terminal configured to play a video casino game, such as slots, keno, poker, blackjack, roulette, craps, etc. The gaming terminal 10 may take any suitable form, such as floor-standing models as shown, handheld mobile units, bartop models, workstation-type console models, etc. Further, the gaming terminal 10 may be primarily dedicated for use in conducting wagering games, or may include non-dedicated devices, such as mobile phones, personal digital assistants, personal computers, etc. Exemplary types of gaming terminals are disclosed in U.S. Pat. No. 6,517,433 and Patent Application Publication Nos. US2010/0062196 and US2010/0234099, which are incorporated herein by reference in their entireties.

The gaming terminal 10 illustrated in FIG. 1 comprises a cabinet 11 that may house various input devices, output devices, and input/output devices. By way of example, the gaming terminal 10 includes a primary display area 12, a secondary display area 14, and one or more audio speakers 16. The primary display area 12 or the secondary display area 14 may be a mechanical-reel display, a video display, or a combination thereof in which a transmissive video display is disposed in front of the mechanical-reel display to portray a video image superimposed upon the mechanical-reel display. The display areas may variously display information associated with wagering games, non-wagering games, community games, progressives, advertisements, services, premium entertainment, text messaging, emails, alerts, announcements, broadcast information, subscription information, etc. appropriate to the particular mode(s) of operation of the gaming terminal 10. The gaming terminal 10 includes a touch screen(s) 18 mounted over the primary or secondary areas, buttons 20 on a button panel, bill validator 22, information reader/writer(s) 24, and player-accessible port(s) 26 (e.g., audio output jack for headphones, video headset jack, USB port, wireless transmitter/receiver, etc.). It should be understood that numerous other peripheral devices and other elements exist and are readily utilizable in any number of combinations to create various forms of a gaming terminal in accord with the present concepts.

Input devices, such as the touch screen 18, buttons 20, a mouse, a joystick, a gesture-sensing device, a voice-recognition device, and a virtual input device, accept player input(s) and transform the player input(s) to electronic data signals indicative of the player input(s), which correspond to an enabled feature for such input(s) at a time of activation (e.g., pressing a “Max Bet” button or soft key to indicate a player's desire to place a maximum wager to play the wagering game). The input(s), once transformed into electronic data signals, are output to a CPU for processing. The electronic data signals are selected from a group consisting essentially of an electrical current, an electrical voltage, an electrical charge, an optical signal, an optical element, a magnetic signal, and a magnetic element.

Turning now to FIG. 2, there is shown a block diagram of the gaming-terminal architecture. The gaming terminal 10 includes a central processing unit (CPU) 30 connected to a main memory 32. The CPU 30 may include any suitable processor(s), such as those made by Intel and AMD. By way of example, the CPU 30 includes a plurality of microprocessors including a master processor, a slave processor, and a secondary or parallel processor. CPU 30, as used herein, comprises any combination of hardware, software, or firmware disposed in or outside of the gaming terminal 10 that is configured to communicate with or control the transfer of data between the gaming terminal 10 and a bus, another computer, processor, device, service, or network. The CPU 30 comprises one or more controllers or processors and such one or more controllers or processors need not be disposed proximal to one another and may be located in different devices or in different locations. The CPU 30 is operable to execute all of the various gaming methods and other processes disclosed herein. The main memory 32 includes a wagering game unit 34. In one embodiment, the wagering game unit 34 may present wagering games, such as video poker, video black jack, video slots, video lottery, etc., in whole or part.

The CPU 30 is also connected to an input/output (I/O) bus 36, which can include any suitable bus technologies, such as an AGTL+ frontside bus and a PCI backside bus. The I/O bus 36 is connected to various input devices 38, output devices 40, and input/output devices 42 such as those discussed above in connection with FIG. 1. The I/O bus 36 is also connected to storage unit 44 and external system interface 46, which is connected to external system(s) 48 (e.g., wagering game networks).

The external system 48 includes, in various aspects, a gaming network, other gaming terminals, a gaming server, a remote controller, communications hardware, or a variety of other interfaced systems or components, in any combination. In yet other aspects, the external system 48 may comprise a player's portable electronic device (e.g., cellular phone, electronic wallet, etc.) and the external system interface 46 is configured to facilitate wireless communication and data transfer between the portable electronic device and the CPU 30, such as by a near-field communication path operating via magnetic-field induction or a frequency-hopping spread spectrum RF signals (e.g., Bluetooth, etc.).

The gaming terminal 10 optionally communicates with the external system 48 such that the terminal operates as a thin, thick, or intermediate client. In general, a wagering game includes an RNG for generating a random number, game logic for determining the outcome based on the randomly generated number, and game assets (e.g., art, sound, etc.) for presenting the determined outcome to a player in an audio-visual manner. The RNG, game logic, and game assets are contained within the gaming terminal 10 (“thick client” gaming terminal), the external system 48 (“thin client” gaming terminal), or are distributed therebetween in any suitable manner (“intermediate client” gaming terminal).

The gaming terminal 10 may include additional peripheral devices or more than one of each component shown in FIG. 2. Any component of the gaming terminal architecture may include hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic disk storage media, optical storage media, flash memory, etc.

Referring now to FIG. 3, there is illustrated an image of a basic-game screen 50 adapted to be displayed on the primary display area 12 or the secondary display area 14. The basic-game screen 50 portrays a plurality of mechanical reels 52. Alternatively or additionally, the basic-game screen 50 portrays a plurality of simulated symbol-bearing reels or other video or mechanical presentation consistent with the game format and theme. The basic-game screen 50 also advantageously displays one or more game-session credit meters 54 and various touch screen buttons 56 adapted to be actuated by a player. A player can operate or interact with the wagering game using these touch screen buttons or other input devices such as the buttons 20 shown in FIG. 1. The CPU operate(s) to execute a wagering game program causing the primary display area 12 or the secondary display area 14 to display the wagering game (e.g., using the plurality of mechanical reels 52).

In response to receiving a wager, the reels 52 are rotated and stopped to place symbols on the reels in visual association with paylines such as paylines 58. The wagering game evaluates the displayed array of symbols on the stopped reels 52 and provides immediate awards and bonus features in accordance with a pay table. The pay table may, for example, include “line pays” or “scatter pays.” Line pays occur when a predetermined type and number of symbols appear along an activated payline, typically in a particular order such as left to right, right to left, top to bottom, bottom to top, etc. Scatter pays occur when a predetermined type and number of symbols appear anywhere in the displayed array without regard to position or paylines. Similarly, the wagering game may trigger bonus features based on one or more bonus triggering symbols appearing along an activated payline (i.e., “line trigger”) or anywhere in the displayed array (i.e., “scatter trigger”). The wagering game may also provide mystery awards and features independent of the symbols appearing in the displayed array.

In accord with various methods of conducting a wagering game on a gaming system in accord with the present concepts, the wagering game includes a game sequence in which a player makes a wager and a wagering game outcome is provided or displayed in response to the wager being received or detected. The wagering game outcome is then revealed to the player in due course following initiation of the wagering game (e.g., using the plurality of mechanical reels 52 to display the wagering game outcome). The method comprises the acts of conducting the wagering game using a gaming apparatus, such as the gaming terminal 10 depicted in FIG. 1, following receipt of an input from the player to initiate the wagering game. The gaming terminal 10 then communicates the wagering game outcome to the player via one or more output devices (e.g., primary display 12 or secondary display 14, the plurality of mechanical reels 52, etc.) through the display of information such as, but not limited to, text, graphics, static images, moving images, etc., or any combination thereof. In accord with the method of conducting the wagering game, the CPU transforms a physical player input, such as a player's pressing of a “Spin Reels” touch key, into an electronic data signal indicative of an instruction relating to the wagering game (e.g., an electronic data signal bearing data on a wager amount).

In the aforementioned method, for each data signal, the CPU (e.g., CPU 30) is configured to process the electronic data signal, to interpret the data signal (e.g., data signals corresponding to a wager input), and to cause further actions associated with the interpretation of the signal in accord with computer instructions relating to such further actions executed by the controller. As one example, the CPU causes the recording of a digital representation of the wager in one or more storage media (e.g., storage unit 44), the CPU, in accord with associated computer instructions, causing the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM), etc. The noted second state of the data storage media comprises storage in the storage media of data representing the electronic data signal from the CPU (e.g., the wager in the present example). As another example, the CPU further, in accord with the execution of the instructions relating to the wagering game, causes the primary display 12 and/or the plurality of mechanical reels 52, other display device, or other output device (e.g., speakers, lights, communication device, etc.) to change from a first state to at least a second state, wherein the second state of the primary display comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of computer instructions relating to the wagering game is further conducted in accord with a random outcome (e.g., determined by a RNG) that is used by the CPU to determine the outcome of the game sequence, using a game logic for determining the outcome based on the randomly generated number. In at least some aspects, the CPU is configured to determine an outcome of the game sequence at least partially in response to the random parameter.

Referring back to FIG. 3, the basic-game screen 50 includes an array of symbol positions 110 used in conducting the wagering game. The array of symbol positions 110 is a 3×5 matrix of symbol positions arranged in five columns and three rows (i.e., fifteen symbol positions). The array of symbol positions 110 is populated by the symbol-bearing mechanical reels 52 such that each of the symbol positions can be associated with one of a plurality of symbols 120 on one of the mechanical reels 52 depending on the rotational position of the mechanical reel 52. Thus, as the mechanical reels 52 rotate, the symbol positions are associated with various ones of the symbols 120 on the mechanical reels 52. When the mechanical reels 52 stop spinning and each of the symbol positions of the array of symbol positions 110 is associated with one of the symbols 120, an outcome of the wagering game is displayed, which can be evaluated to determine if it is a winning outcome. In order to properly evaluate the outcome to determine if it is winning, and for aesthetic reasons, it is important for the mechanical reels 52 to stop such that each of the visible symbols 120 aligns with one of the symbol positions in a predetermined fashion. While the array of symbol positions 110 is shown as including five columns and three symbol positions per column (i.e., three rows of symbol positions), any number of columns and rows can be provided. For example, the array of symbol positions can include 1, 2, 3, 4, 10, 20, n, etc. columns with 1, 2, 3, 4, 10, m, etc. rows.

Referring to FIG. 4, a schematic diagram of a portion of a gaming terminal 100 illustrates that the gaming terminal 100 includes a game CPU 130, a reel control microcontroller 131 (e.g., a motor controller), a plurality of reel motors 151a-151n, a plurality of mechanical reels 152a-152n (e.g., symbol-bearing reels), and a plurality of cameras 160a-160n. The gaming terminal 100 is the same as, or similar to, the gaming terminal 10 described herein, except that the gaming terminal 100 additionally includes the plurality of cameras 160a-160n within a housing 111 of the gaming terminal 100.

Generally, the game CPU 130 is for conducting one or more wagering games (e.g., one or more basic wagering games, one or more bonus games, one or more community games, etc.) on the gaming terminal 100 by executing game software (e.g., game software stored in a main memory of the gaming terminal 100). The reel control microcontroller 131 is generally for controlling the reel motors 151a-151n. The reel control microcontroller 131 receives instructions from the game CPU 130 that causes the reel control microcontroller 131 to selectively activate and/or deactivate one or more of the reel motors 151a-151n.

The game CPU 130 can be the same as, or similar to, the CPU 30 of the gaming terminal 10. Further, the reel control microcontroller 131 can be the same as, or similar to, the CPU 30 of the gaming terminal 10. That is, the CPU 30 of gaming terminal 10 can include a game CPU (e.g., the game CPU 130) and a reel control microcontroller (e.g., the reel control microcontroller 131).

As shown in FIG. 4, each of the mechanical reels 152a-152n is coupled with a respective one of the reel motors 151a-151n such that activation of a respective one of the reel motors 151a-151n results in a corresponding rotation of a respective one of the mechanical reels 152a-152n. For example, initially a randomly selected game outcome is selected to be displayed by the mechanical reels 52. In order to properly display the selected outcome, the game CPU 130 first instructs the reel control microcontroller 131 to cause the first reel motor 151a to rotate the first mechanical reel 152a to a first position (e.g., a first rotational position). In response to that instruction, the reel control microcontroller 131 activates the first reel motor 151a (e.g., turns the first reel motor 151a ON) until the first mechanical reel 152a (coupled thereto) reaches the first position. Then the reel control microcontroller 131 deactivates the first reel motor 151a (e.g., turns the first reel motor 151a OFF) such that the first mechanical reel 152a is in the first position and bears a first symbol thereon in association with a first symbol position as part of the randomly selected game outcome. Of course, the reel control microcontroller 131 can cause the first mechanical reel 152a to spin more than one complete spin (e.g., 360 degrees) prior to deactivating the first reel motor 151a to add excitement and anticipation to the game outcome. Further, in order to display the rest of the randomly selected game outcome, the other ones of the mechanical reels are rotated by their respective reel motors to specific rotational positions such that each of the other reels bears at least one symbol thereon in association with respective symbol positions as part of the randomly selected game outcome (see e.g., FIG. 3 for a game outcome being displayed).

Each of the mechanical reels 152a-152n includes a reel cage and a strip of symbols attached thereto. Specifically, for example, as shown in FIG. 5, the first mechanical reel 152a includes a first reel cage 153a with an attached first strip of symbols 154a. The first strip of symbols 154a is wrapped around the first reel cage 153a such that as the first reel cage 153a is rotated, the first strip of symbols 154a rotates therewith. The first strip of symbols 154a can be, for example, a strip of paper or other flexible material (e.g., plastic) with symbols printed thereon in a spaced relationship such that the first strip of symbols 154a can be bent around the first reel cage 153a and attached thereto using, for example, glue, tape, locking tabs, positioning pins, etc. According to some implementations, each of the reel strips includes multiple layers which are laminated together prior to being attached to a reel cage within the gaming terminal. The symbols are printed in a spaced relationship such that, for example, when the reel 152a is stopped, each of the visible symbols on the reel 152a only occupies a respective symbol position.

Generally, each of the strips of symbols of the mechanical reels 152a-152n can be identical or different. In some implementations, each of the strips of symbols includes the same or similar symbols but just in a different order and/or frequency. For example, in some implementations, the symbols can all be letters of the alphabet (e.g., symbol “A,” symbol “B,” symbol “Z,” etc.). In some such implementations, a first one of the strips of symbols might include symbols in following order: A, B, C, D, E, F, G, H, I, J, K, L, M, N, O, P, Q, R, S, T, U, V, W, X, Y, Z; whereas a second one of the strips of symbols might include symbols in the following order: A, B, C, D, E, F, G, H, I, J, K, L, M, A, B, C, D, E, F, G, H, I, J, K, L, M; whereas a third one of the strips of symbols might include symbols in the following order: A, B, C, D, E, A, B, C, D, E, A, B, C, D, E, A, B, C, D, E, A, B, C, D, E, A; whereas a fourth one of the strips of symbols might include symbols in the following order: A, A, A, A, B, C, D, D, D, D, E, E, E, A, B, B, C, D, E, A, B, C, D, E, A, B, etc. As such, the symbols on the first, the second, the third, and the fourth strips of symbols are related (e.g., they are all symbols of letters of the alphabet); however, the strips of symbols are different. By the symbols being related, it is meant that the symbols on the different strips of symbols can be part of the same theme (e.g., WIZARD OF OZ theme, cartoon theme, etc.) without being identically printed on the strips.

The gaming terminal 100 can be configured to conduct a variety of wagering games. Each of the wagering games that can be conducted on the gaming terminal 100 has its own game software with a different theme that uses different symbols. As such, it is important to install the “correct” strips of symbols on the reel cages after a particular wagering game is selected and installed in the gaming terminal 100 (e.g., after game software is loaded on the main memory of the gaming terminal 100). By correct strips of symbols it is meant that the strips of symbols that are installed (e.g., attached to the reel cages) need to match and/or correspond with the gaming software installed on the gaming terminal 100.

Additionally, it is important to install the strips of symbols in the “correct” position on the reel cages relative to the rest of the gaming terminal 100. By correct position it is meant that the strips are attached to the reel cages in a predefined relationship (e.g., the strips are properly oriented within the gaming terminal). As such, when the reel control microcontroller 131 instructs the first reel motor 151a to rotate the first mechanical reel 152a to a predefined rotational position—such that a specific symbol on the first mechanical reel 152a is associated with a specific symbol position of the randomly selected outcome—the proper (e.g., intended) symbol on the first mechanical reel 152a is displayed (e.g., associated with the desired symbol position).

In order to verify that the correct strips of symbols are installed in the correct position, the cameras 160a-160n can be placed inside the gaming terminal 100 and aimed at respective ones of the mechanical reels 152a-152n. For example, as best shown in FIG. 5, the first camera 160a is mounted to the housing 111 (e.g., the same as, or similar to, the housing 11 of the gaming terminal 10) of the gaming terminal 100 and aimed at the first mechanical reel 152a of the gaming terminal 100. As such, the first camera is able to video and/or image (e.g., monitor) the first mechanical reel 152a, for example, during rotation (e.g., spinning) of first mechanical reel 152a. In particular, the first camera 160a can generate image data associated with the first strip of symbols 154a of the first mechanical reel 152a. The generated image data associated with the first strip of symbols 154a can be reproduced as a visually readable image of the first strip of symbols 154a in whole or in part. In some implementations, each of the cameras 160a-160n is able to generate images a variety of rates, such as, for example, at rate of at least two hertz, at a rate of at least five hertz, at a rate of at least twenty hertz, etc. In some implementations, each of the cameras 160a-160n is able to generate images at least three times per rotation of the corresponding mechanical reel 152a-152n.

The generated image data can be sent to the reel control microcontroller 131 (shown in FIG. 4) for further processing by, for example, the reel control microcontroller 131 and/or the game CPU 130. In some implementations, the generated image data can be compared with master image data associated with the game software installed on the gaming terminal to determine if the first strip of symbols 154a is correct (e.g., determine if the symbols are associated with (e.g., matches) the strip of symbols intended to be used with the installed game software on the first mechanical reel 152a) and if the first strip of symbols 154a is properly aligned (e.g., attached to the first reel cage 153a in the intended position/relationship). In some implementations, the generated image data can be compared with master image data associated with the game software installed on the gaming terminal and/or otherwise be analyzed to determine a rotational velocity of the corresponding mechanical reel. In some implementations, the generated image data can be compared with master image data associated with the game software installed on the gaming terminal and/or otherwise be analyzed to determine if the strip of symbols on a corresponding one of the mechanical reels has been tampered with and/or altered (e.g., extra marks on the strip, tears, missing symbols, covered symbols, etc.).

If the reel control microcontroller 131 and/or the game CPU 130 determines, based on such a comparison, that the first strip of symbols 154a is correct and correctly installed, the reel control microcontroller 131 and/or the game CPU 130 can permit the wagering game to be conducted on the gaming terminal 100 as intended. However, if the reel control microcontroller 131 and/or the game CPU 130 determines, based on such a comparison, that the first strip of symbols 154a is incorrect (e.g., does not correspond with and/or match the strip of symbols intended to be used with the installed game software on the first mechanical reel 152a), or was not properly installed, the reel control microcontroller 131 and/or the game CPU 130 can prevent the wagering game from being conducted on the gaming terminal 100 and/or take one or more predetermined actions. For example, an email (e.g., an electronic notice) can be generated and sent over a network coupled to the gaming terminal 100 to a supervisor that is tasked with maintaining the integrity of the gaming terminal 100. For another example, a message can be displayed on the primary and/or secondary display area 12, 14 indicating that the wrong strip of symbols is installed on the first reel cage 153a. For yet another example, a message can be displayed on the primary and/or secondary display area 12, 14 indicating that the strip of symbols needs to be calibrated (e.g., the position of the strip of reel symbols needs to be rotated). Various additional predetermined actions can occur in addition thereto or in lieu thereof.

According to some implementations, the reel microcontroller 131 and/or the game CPU 130 can automatically calibrate the position of the strip of symbols. That is, the strip of symbols can be installed anywhere on the reel cage and then the reel microcontroller 131 and/or the game CPU 130 can automatically calibrate the gaming terminal 100 to display the randomly selected outcomes properly by analyzing (e.g., using the generated image data) the actual position(s) of the strip(s) of symbols on the reel cage(s) and then adjusting the rotational position of the mechanical reel(s) 152a-152n accordingly.

According to some implementations, the cameras 160a-160n can be used to verify that the “correct” symbols are displayed by the mechanical reels 152a-152n after the mechanical reels 152a-152n have stopped spinning By correct symbols it is meant that the symbols associated with the symbol positions forming the actual displayed outcome correspond with the intended randomly selected game outcome.

As shown in FIG. 4, each mechanical reel 152a-152n of the gaming terminal 100 is associated with its own one of the cameras 160a-160n; however, in some alternative implementations, two or more of the mechanical reels 152a-152n can share a camera. For example, in some implementations, all five mechanical reels (e.g., mechanical reels 52 shown in FIG. 3) of a gaming terminal (e.g., gaming terminal 10 of FIG. 1) share a single camera (not shown).

According to some implementations, the cameras 160a-160n can be used to determine the rotational position of the mechanical reels 152a-152n. Specifically, the image data generated by the cameras 160a-160n can be analyzed by, for example, the game CPU 130 and/or the reel control microcontroller 131 to determine the rotational position of one or more of the symbols thereon. Use of the cameras 160a-160n allows for the determination of the rotational positions of the mechanical reels 152a-152n without use of an encoder strip which was previously used for such determinations, thus, in some implementations, simplifying the mechanical arrangement within the gaming terminal 100 as compared to prior terminals with an encoder strip.

### ALTERNATIVE EMBODIMENTS

### Alternative Embodiment 1

A method of conducting a wagering game on a gaming terminal, comprising: receiving, via an input device, a wager to play the wagering game; spinning a plurality of symbol bearing reels using one or more motors of the gaming terminal; during the spinning, monitoring the symbols on a first one of the reels using one or more video cameras to generate image data associated with the symbols on the first reel; comparing the generated image data associated with the symbols on the first reel with master image data associated with the wagering game; and based on the comparing, determining if the symbols on the first reel are associated with the wagering game being conducted on the gaming terminal.

### Alternative Embodiment 2

The method of Alternative Embodiment 1, further comprising determining that the symbols on the first reel are associated with the wagering game being conducted on the gaming terminal.

### Alternative Embodiment 3

The method of Alternative Embodiment 2, further comprising in response to the determining that the symbols on the first reel are associated with the wagering game, permitting further conducting of the wagering game on the gaming terminal.

### Alternative Embodiment 4

The method of Alternative Embodiment 1, further comprising determining that the symbols on the first reel are not associated with the wagering game being conducted on the gaming terminal.

### Alternative Embodiment 5

The method of Alternative Embodiment 4, further comprising in response to the determining that the symbols on the first reel are not associated with the wagering game, preventing further conducting of the wagering game on the gaming terminal.

### Alternative Embodiment 6

The method of Alternative Embodiment 4, further comprising in response to the determining that the symbols on the first reel are not associated with the wagering game, transmitting an electronic notice from the gaming terminal, the electronic notice being indicative of the incorrect symbol usage on the gaming terminal.

### Alternative Embodiment 7

The method of Alternative Embodiment 1, further comprising based on the comparing, determining if the symbols on the first reel are properly oriented within the gaming terminal.

### Alternative Embodiment 8

The method of Alternative Embodiment 1, wherein each of the plurality of symbol bearing reels is a mechanical reel that physically spins within the gaming terminal.

### Alternative Embodiment 9

The method of Alternative Embodiment 8, wherein each of the plurality of symbol bearing reels includes a reel cage and a strip of symbols attached thereto.

### Alternative Embodiment 10

The method of Alternative Embodiment 1, further comprising based on the comparing, determining a rotational position of the first reel and the symbols thereon.

### Alternative Embodiment 11

The method of Alternative Embodiment 10, wherein the determining the rotational position is accomplished without using an encoder strip coupled to the first reel.

### Alternative Embodiment 12

The method of Alternative Embodiment 1, wherein the monitoring includes imaging, via the one or more video cameras, the first reel at a rate of at least two hertz.

### Alternative Embodiment 13

The method of Alternative Embodiment 1, wherein the monitoring includes imaging, via the one or more video cameras, the first reel at a rate of at least five hertz.

### Alternative Embodiment 14

The method of Alternative Embodiment 1, wherein the monitoring includes imaging, via the one or more video cameras, the first reel at a rate of at least twenty hertz.

### Alternative Embodiment 15

The method of Alternative Embodiment 1, wherein the monitoring includes imaging, via the one or more video cameras, the first reel at least three times per rotation of the first reel.

### Alternative Embodiment 16

The method of Alternative Embodiment 15, further comprising communicating the image data associated with the symbols on the first reel to a motor controller electrically coupled to at least one of the one or more motors spinning the first reel.

### Alternative Embodiment 17

The method of Alternative Embodiment 16, wherein the comparing includes comparing, using the motor controller, the communicated image data with the master image data to ensure the symbols on the first reel are in the proper position.

### Alternative Embodiment 18

The method of Alternative Embodiment 1, further comprising based on the comparing, determining a rotational velocity of the first reel.

### Alternative Embodiment 19

The method of Alternative Embodiment 1, further comprising determining that the symbols on the first reel have not been tampered with or altered.

### Alternative Embodiment 20

A method of verifying proper reel strip usage in an electronic gaming machine (“EGM”), the method comprising: storing game software on a memory of the EGM that is executable by one or more processors of the EGM to play a wagering game on the EGM, the game software being associated with a first plurality of symbols; providing a strip of symbols on each one of a plurality of reel cages in the EGM for use in playing the wagering game, thereby forming a plurality of symbol bearing reels; spinning, using one or more motors of the EGM, the plurality of symbol bearing reels under the control of at least one of the one or more processors of the EGM; monitoring, during the spinning, using one or more video cameras of the EGM, the plurality of symbol bearing reels; in response to the monitoring, generating image data associated with each of the symbol bearing reels; comparing, using at least one of the one or more processors of the EGM, the generated image data associated with each of the symbol bearing reels with the first plurality of symbols associated with the game software stored on the memory of the EGM; and based on the comparing, verifying if the provided strip of symbols on each one of the reel cages corresponds with the first plurality of symbols associated with the game software.

### Alternative Embodiment 21

The method of Alternative Embodiment 20, further comprising based on the comparing, for each of the symbol bearing reels, verifying that the provided strip of symbols is attached to the reel cage in a predefined manner.

### Alternative Embodiment 22

The method of Alternative Embodiment 20, further comprising determining that the provided strip of symbols on each one of the reel cages does correspond with the first plurality of symbols associated with the game software.

### Alternative Embodiment 23

The method of Alternative Embodiment 22, further comprising in response to the determining that the provided strip of symbols on each one of the reel cages does correspond with the first plurality of symbols associated with the game software, permitting a player to play the wagering game on the EGM.

### Alternative Embodiment 24

The method of Alternative Embodiment 20, further comprising determining that the provided strip of symbols on at least one of the reel cages does not correspond with the first plurality of symbols associated with the game software.

### Alternative Embodiment 25

The method of Alternative Embodiment 24, further comprising in response to the determining that the provided strip of symbols on the at least one of the reel cages does not correspond with the first plurality of symbols associated with the game software, preventing a player from playing the wagering game on the EGM.

### Alternative Embodiment 26

The method of Alternative Embodiment 24, further comprising in response to the determining that the provided strip of symbols on the at least one of the reel cages does not correspond with the first plurality of symbols associated with the game software, displaying, on a display device of the EGM, a “Wrong Reel Strip Installed” notice.

### Alternative Embodiment 27

The method of Alternative Embodiment 20, further comprising based on the comparing, determining if the strip of symbols on each one of the reel cages is properly oriented within the EGM.

### Alternative Embodiment 28

The method of Alternative Embodiment 20, wherein each of the plurality of symbol bearing reels is a mechanical reel that physically spins within the EGM.

### Alternative Embodiment 29

The method of Alternative Embodiment 20, wherein the monitoring includes imaging, via the one or more video cameras, each of the plurality of symbols bearing reels at a rate of at least two hertz.

### Alternative Embodiment 30

The method of Alternative Embodiment 20, wherein the monitoring includes imaging, via the one or more video cameras, each of the plurality of symbols bearing reels at a rate of at least five hertz.

### Alternative Embodiment 31

The method of Alternative Embodiment 20, wherein the monitoring includes imaging, via the one or more video cameras, each of the plurality of symbols bearing reels at a rate of at least twenty hertz.

### Alternative Embodiment 32

The method of Alternative Embodiment 20, wherein the monitoring includes imaging, via the one or more video cameras, each of the plurality of symbols bearing reels at least three times per rotation of each of the plurality of symbols bearing reels.

### Alternative Embodiment 33

The method of Alternative Embodiment 32, further comprising communicating the image data associated with each of the symbol bearing reels to a motor controller electrically coupled to the one or more motors of the EGM spinning the plurality of symbols bearing reels.

### Alternative Embodiment 34

The method of Alternative Embodiment 33, wherein the comparing includes comparing, using the motor controller, the communicated image data with the first plurality of symbols associated with the game software stored on the memory of the EGM to ensure the symbols on the plurality of symbol bearing reels are in the proper position.

### Alternative Embodiment 35

The method of Alternative Embodiment 20, further comprising based on the comparing, determining a rotational velocity of one or more of the plurality of symbol bearing reels.

### Alternative Embodiment 36

The method of Alternative Embodiment 20, further comprising determining that the symbols on one or more of the plurality of symbol bearing reels have not been tampered with or altered.

### Alternative Embodiment 37

A gaming system for conducting a wagering game, the gaming system comprising: one or more symbol bearing reels; one or more motors; one or more video cameras; one or more processors; and one or more memory devices storing instructions that, when executed by at least one of the one or more processors, cause the gaming system to: receive, via an input device of the gaming system, a wager to conduct the wagering game; spin the one or more symbol bearing reels using the one or more motors; during the spinning, monitor the symbols on a first one of the symbol bearing reels using the one or more video cameras to generate image data associated with the symbols on the first symbol bearing reel; compare the generated image data associated with the symbols on the first symbol bearing reel with master image data associated with the wagering game; and based on the comparing, determine if the symbols on the first symbol bearing reel are associated with the wagering game being conducted on the gaming system.

### Alternative Embodiment 38

The gaming system of Alternative Embodiment 37, wherein the gaming system is further caused to determine that the symbols on the first symbol bearing reel are associated with the wagering game being conducted on the gaming terminal.

### Alternative Embodiment 39

The gaming system of Alternative Embodiment 38, wherein in response to the determining that the symbols on the first symbol bearing reel are associated with the wagering game, the gaming system is further caused to permit further conducting of the wagering game on the gaming terminal.

### Alternative Embodiment 40

The gaming system of Alternative Embodiment 37, wherein the gaming system is further caused to determine that the symbols on the first symbol bearing reel are not associated with the wagering game being conducted on the gaming terminal.

### Alternative Embodiment 41

The gaming system of Alternative Embodiment 40, wherein in response to the determining that the symbols on the first reel are not associated with the wagering game, the gaming system is further caused to prevent further conducting of the wagering game on the gaming terminal.

### Alternative Embodiment 42

The gaming system of Alternative Embodiment 40, wherein in response to the determining that the symbols on the first reel are not associated with the wagering game, the gaming system is further caused to transmit an electronic notice from the gaming terminal, the electronic notice being indicative of the incorrect symbol usage on the gaming terminal.

### Alternative Embodiment 43

The gaming system of Alternative Embodiment 37, wherein the gaming system is further caused to, based on the comparing, determine if the symbols on the first symbol bearing reel are properly oriented within the gaming system.

### Alternative Embodiment 44

The gaming system of Alternative Embodiment 37, wherein each of the symbol bearing reels is a mechanical reel that is configured to physically spin within the gaming system.

### Alternative Embodiment 45

The gaming system of Alternative Embodiment 44, wherein each of the symbol bearing reels includes a reel cage and a strip of symbols attached thereto.

### Alternative Embodiment 46

The gaming system of Alternative Embodiment 37, wherein the gaming system is further caused to, based on the comparing, determine a rotational position of the first symbol bearing reel and the symbols thereon.

### Alternative Embodiment 47

The gaming system of Alternative Embodiment 46, wherein the gaming system is further caused to determine the rotational position without using an encoder strip coupled to the first symbol bearing reel.

### Alternative Embodiment 48

The gaming system of Alternative Embodiment 37, wherein the monitoring includes imaging, via the one or more video cameras, the first symbol bearing reel at a rate of at least two hertz.

### Alternative Embodiment 49

The gaming system of Alternative Embodiment 37, wherein the monitoring includes imaging, via the one or more video cameras, the first symbol bearing reel at a rate of at least five hertz.

### Alternative Embodiment 50

The gaming system of Alternative Embodiment 37, wherein the monitoring includes imaging, via the one or more video cameras, the first symbol bearing reel at a rate of at least twenty hertz.

### Alternative Embodiment 51

The gaming system of Alternative Embodiment 37, wherein the monitoring includes imaging, via the one or more video cameras, the first symbol bearing reel at least three times per rotation of the first symbol bearing reel.

### Alternative Embodiment 52

The gaming system of Alternative Embodiment 51, wherein the gaming system is further caused to communicate the image data associated with the symbols on the first symbol bearing reel to a motor controller electrically coupled to at least one of the one or more motors spinning the first symbol bearing reel.

### Alternative Embodiment 53

The gaming system of Alternative Embodiment 52, wherein the gaming system is further caused to compare, using the motor controller, the communicated image data with the master image data to ensure the symbols on the first symbol bearing reel are in the proper position.

### Alternative Embodiment 54

The gaming system of Alternative Embodiment 37, wherein the gaming system is further caused to, based on the comparing, determine a rotational velocity of the first symbol bearing reel.

### Alternative Embodiment 55

The gaming system of Alternative Embodiment 37, wherein the gaming system is further caused to determine that the symbols on the first symbol bearing reel have not been tampered with or altered.

### Alternative Embodiment 56

A gaming system for conducting a wagering game, the gaming system comprising: a plurality of symbol bearing reels, each of the symbol bearing reels including a reel cage and a strip of symbols attached thereto for use in playing the wagering game; a plurality of motors; one or more video cameras; one or more processors; and one or more memory devices storing game software that is executable by at least one of the one or more processors to play the wagering game, the game software being associated with a first plurality of symbols, at least one of the one or more memory devices storing instructions that, when executed by at least one of the one or more processors, cause the gaming system to: spin, using the plurality of motors, the symbol bearing reels under the control of at least one of the one or more processors; monitor, during the spinning, using the one or more video cameras, the symbol bearing reels; in response to the monitoring, generate image data associated with each of the symbol bearing reels; compare, using at least one of the one or more processors, the generated image data associated with each of the symbol bearing reels with the first plurality of symbols associated with the game software stored on the one or more memory devices; and based on the comparing, verify if the strip of symbols attached to each one of the reel cages corresponds with the first plurality of symbols associated with the game software.

### Alternative Embodiment 57

The gaming system of Alternative Embodiment 56, wherein the gaming system is further caused to, based on the comparing, for each of the symbol bearing reels, verify that the strip of symbols is attached to the reel cage in a predefined manner.

### Alternative Embodiment 58

The gaming system of Alternative Embodiment 56, wherein the gaming system is further caused to determine that the strip of symbols attached to each one of the reel cages corresponds with the first plurality of symbols associated with the game software.

### Alternative Embodiment 59

The gaming system of Alternative Embodiment 58, wherein in response to the determining that the strip of symbols attached to each one of the reel cages corresponds with the first plurality of symbols associated with the game software, the gaming system is further caused to permit a player to play the wagering game on the gaming system.

### Alternative Embodiment 60

The gaming system of Alternative Embodiment 56, wherein the gaming system is further caused to determine that the strip of symbols attached to at least one of the reel cages does not correspond with the first plurality of symbols associated with the game software.

### Alternative Embodiment 61

The gaming system of Alternative Embodiment 60, wherein in response to the determining that the strip of symbols attached to the at least one of the reel cages does not correspond with the first plurality of symbols associated with the game software, the gaming system is further caused to prevent a player from playing the wagering game on the gaming system.

### Alternative Embodiment 62

The gaming system of Alternative Embodiment 60, wherein in response to the determining that the strip of symbols attached to the at least one of the reel cages does not correspond with the first plurality of symbols associated with the game software, the gaming system is further caused to display, on one or more display devices of the gaming system, a “Wrong Reel Strip Installed” notice.

### Alternative Embodiment 63

The gaming system of Alternative Embodiment 56, wherein the gaming system is further caused to, based on the comparing, determine if the strip of symbols attached to each one of the reel cages is properly oriented within the gaming system.

### Alternative Embodiment 64

The gaming system of Alternative Embodiment 56, wherein each of the plurality of symbol bearing reels is a mechanical reel that is configured to physically spin within the gaming system.

### Alternative Embodiment 65

The gaming system of Alternative Embodiment 56, wherein the monitoring includes imaging, via the one or more video cameras, each of the plurality of symbols bearing reels at a rate of at least two hertz.

### Alternative Embodiment 66

The gaming system of Alternative Embodiment 56, wherein the monitoring includes imaging, via the one or more video cameras, each of the plurality of symbols bearing reels at a rate of at least five hertz.

### Alternative Embodiment 67

The gaming system of Alternative Embodiment 56, wherein the monitoring includes imaging, via the one or more video cameras, each of the plurality of symbols bearing reels at a rate of at least twenty hertz.

### Alternative Embodiment 68

The gaming system of Alternative Embodiment 56, wherein the monitoring includes imaging, via the one or more video cameras, each of the plurality of symbols bearing reels at least three times per rotation of each of the plurality of symbols bearing reels.

### Alternative Embodiment 69

The gaming system of Alternative Embodiment 68, wherein the gaming system is further caused to communicate the image data associated with each of the symbol bearing reels to a motor controller electrically coupled to at least one of the plurality of motors spinning the plurality of symbols bearing reels.

### Alternative Embodiment 70

The gaming system of Alternative Embodiment 69, wherein the gaming system is further caused to compare, using the motor controller, the communicated image data with the first plurality of symbols associated with the game software stored on the one or more memory devices to ensure the symbols on the plurality of symbol bearing reels are in the proper position.

### Alternative Embodiment 71

The gaming system of Alternative Embodiment 56, wherein the gaming system is further caused to, based on the comparing, determine a rotational velocity of one or more of the plurality of symbol bearing reels.

### Alternative Embodiment 72

The gaming system of Alternative Embodiment 56, wherein the gaming system is further caused to determine that the symbols on one or more of the plurality of symbol bearing reels have not been tampered with or altered.

Each of the above concepts and obvious variations thereof is contemplated as falling within the spirit and scope of the claimed invention, which is set forth in the following claims.

1. A method of conducting a wagering game on a gaming terminal, comprising:
receiving, via an input device, a wager to play the wagering game;
spinning a plurality of symbol bearing reels using one or more motors of the gaming terminal;
during the spinning, monitoring the symbols on a first one of the reels using one or more video cameras to generate image data associated with the symbols on the first reel;
comparing the generated image data associated with the symbols on the first reel with master image data associated with the wagering game; and
based on the comparing, determining if the symbols on the first reel are associated with the wagering game being conducted on the gaming terminal.

2. The method of claim 1, further comprising determining that the symbols on the first reel are associated with the wagering game being conducted on the gaming terminal and in response to the determining that the symbols on the first reel are associated with the wagering game, permitting further conducting of the wagering game on the gaming terminal.

3. The method of claim 1, further comprising determining that the symbols on the first reel are not associated with the wagering game being conducted on the gaming terminal and in response to the determining that the symbols on the first reel are not associated with the wagering game: (i) preventing further conducting of the wagering game on the gaming terminal and (ii) transmitting an electronic notice from the gaming terminal, the electronic notice being indicative of the incorrect symbol usage on the gaming terminal.

4. (canceled)

5. The method of claim 1, wherein each of the plurality of symbol bearing reels is a mechanical reel that physically spins within the gaming terminal, and wherein each of the plurality of symbol bearing reels includes a reel cage and a strip of symbols attached thereto.

6. The method of claim 1, further comprising based on the comparing, determining a rotational position of the first reel and the symbols thereon without using an encoder strip coupled to the first reel.

7. The method of claim 1, wherein the monitoring includes imaging, via the one or more video cameras, the first reel at a rate of at least two hertz.

8. The method of claim 1, further comprising communicating the image data associated with the symbols on the first reel to a motor controller electrically coupled to at least one of the one or more motors spinning the first reel, wherein the monitoring includes imaging, via the one or more video cameras, the first reel at least three times per rotation of the first reel, and wherein the comparing includes comparing, using the motor controller, the communicated image data with the master image data to ensure the symbols on the first reel are in the proper position.

9. The method of claim 1, further comprising determining that the symbols on the first reel have not been tampered with or altered.

10. A method of verifying proper reel strip usage in an electronic gaming machine (“EGM”), the method comprising:
storing game software on a memory of the EGM that is executable by one or more processors of the EGM to play a wagering game on the EGM, the game software being associated with a first plurality of symbols;
providing a strip of symbols on each one of a plurality of reel cages in the EGM for use in playing the wagering game, thereby forming a plurality of symbol bearing reels;
spinning, using one or more motors of the EGM, the plurality of symbol bearing reels under the control of at least one of the one or more processors of the EGM;
monitoring, during the spinning, using one or more video cameras of the EGM, the plurality of symbol bearing reels;
in response to the monitoring, generating image data associated with each of the symbol bearing reels;
comparing, using at least one of the one or more processors of the EGM, the generated image data associated with each of the symbol bearing reels with the first plurality of symbols associated with the game software stored on the memory of the EGM; and
based on the comparing, verifying if the provided strip of symbols on each one of the reel cages corresponds with the first plurality of symbols associated with the game software.

11. The method of claim 10, further comprising based on the comparing, for each of the symbol bearing reels, verifying that the provided strip of symbols is attached to the reel cage in a predefined manner.

12. The method of claim 10, further comprising determining that the provided strip of symbols on each one of the reel cages does correspond with the first plurality of symbols associated with the game software, and in response to the determining that the provided strip of symbols on each one of the reel cages does correspond with the first plurality of symbols associated with the game software, permitting a player to play the wagering game on the EGM.

13. (canceled)

14. The method of claim 10, further comprising determining that the provided strip of symbols on at least one of the reel cages does not correspond with the first plurality of symbols associated with the game software.

15. The method of claim 14, further comprising in response to the determining that the provided strip of symbols on the at least one of the reel cages does not correspond with the first plurality of symbols associated with the game software, preventing a player from playing the wagering game on the EGM.

16. The method of claim 14, further comprising in response to the determining that the provided strip of symbols on the at least one of the reel cages does not correspond with the first plurality of symbols associated with the game software, displaying, on a display device of the EGM, a “Wrong Reel Strip Installed” notice.

17. The method of claim 10, further comprising based on the comparing, determining if the strip of symbols on each one of the reel cages is properly oriented within the EGM.

18. The method of claim 10, further comprising determining that the symbols on one or more of the plurality of symbol bearing reels have not been tampered with or altered.

19. A gaming system for conducting a wagering game, the gaming system comprising:
one or more symbol bearing reels;
one or more motors;
one or more video cameras;
one or more processors; and
one or more memory devices storing instructions that, when executed by at least one of the one or more processors, cause the gaming system to:
receive, via an input device of the gaming system, a wager to conduct the wagering game;
spin the one or more symbol bearing reels using the one or more motors;
during the spinning, monitor the symbols on a first one of the symbol bearing reels using the one or more video cameras to generate image data associated with the symbols on the first symbol bearing reel;
compare the generated image data associated with the symbols on the first symbol bearing reel with master image data associated with the wagering game; and
based on the comparing, determine if the symbols on the first symbol bearing reel are associated with the wagering game being conducted on the gaming system.

20. The gaming system of claim 19, wherein the gaming system is further caused to determine that the symbols on the first symbol bearing reel are associated with the wagering game being conducted on the gaming terminal, and wherein in response to the determining that the symbols on the first symbol bearing reel are associated with the wagering game, the gaming system is further caused to permit further conducting of the wagering game on the gaming terminal.

21. The gaming system of claim 19, wherein the gaming system is further caused to determine that the symbols on the first symbol bearing reel are not associated with the wagering game being conducted on the gaming terminal, and wherein in response to the determining that the symbols on the first reel are not associated with the wagering game, the gaming system is further caused to prevent further conducting of the wagering game on the gaming terminal.

22. (canceled)

23. The gaming system of claim 19, wherein each of the symbol bearing reels includes a reel cage and a strip of symbols attached thereto for use in playing the wagering game, and wherein the gaming system is further caused to, based on the comparing, for each of the symbol bearing reels, verify that the strip of symbols is attached to the reel cage in a predefined manner.

24-25. (canceled)
